(19) United States
(12) Patent Application Publication
(10) Pub. No.: US 2005/0137013 A1
(43) Pub. Date: Jun. 23, 2005

(54) Method for displaying and developing casino games

(76) Inventor: Christine C. Parsadaian, Las Vegas, NV (US)

Correspondence Address: WEISS & MOY PC, 4204 NORTH BROWN AVENUE, SCOTTSDALE, AZ, 85251, US

(21) Appl. No.: 10/738,776

(22) Filed: Dec. 17, 2003

(51) Int. Cl. A63F 13/00

(52) U.S. Cl. 463/42

(57) ABSTRACT

A method for displaying casino games to a plurality of users in networked communication with a host. In one embodiment, the games include existing games that may be found in a casino as well as games that are still in development. In exchange for payment of a membership fee, players may engage in the simulated play of such games on a user computer. Preferably, demographic information and/or feedback is obtained from users, and communicated by the host to gaming manufacturers.

### FIELD OF THE INVENTION

This invention relates generally to casino games and, more particularly, to a method for displaying casino games over a computer network and obtaining feedback for such games for possible use in development and/or placement.

### BACKGROUND OF THE INVENTION

The gaming industry is one of the fastest growing market segments. In 1990, gross gambling revenue (“GGR”) posted at $26.6 billion. Ten years later, in 2002, GGR reached $61.4 billion. The casino gaming component of GGR in 1990 was $8.3 billion. In 2000, that amount rose to $24.3 billion.

In 2001, over 51 million adults over the age of 21 visited casinos across the United States. They made 308 million casino visits, an average of 5.8 trips per person. 11 U.S. states now have legalized casino gaming, and are home to more than 430 casinos. Casino gaming on Indian reservations, particularly in California and Connecticut, has also experienced significant growth.

Ownership of personal computers and use of the Internet have also grown substantially in recent years. In 1984, the U.S. Census Bureau reported that 8.2% of households had a home computer. By August 2000, that figure had risen to 51%, or 54 million households. Of this population, 81.4%, or approximately 44 million families, had Internet access.

The majority of casino gaming revenue, perhaps 70% or more, comes from the play of slot machines of various kinds, as opposed to table gaming. Manufacturers regularly introduce new slot machines in an attempt to grab market share. However, the regular turnover of slot machines and the introduction of new games often leaves players confused. Many are reluctant to risk their money on a machine with which they lack familiarity.

In addition, the development of machines is an expensive undertaking. A significant percentage of new machines fail soon after introduction, perhaps as many as 50% or more. It is believed that this can be attributable, at least in significant part, to the failure by manufacturers to properly take into account player preferences and feedback during game design. Of course, the failure of a casino game is accompanied by lost investment, business opportunities, or the like.

It would be desirable to expose casino games, particularly new ones, to players in a convenient, non-wagering setting. In this fashion, players can familiarize themselves with the features of a new game. They can decide if they like the game and, if so, can play it in a casino setting in comfort and with confidence. Preferably, players can also learn about where a particular game may be located, so that they can find and play a desired game.

It would further be desirable to expose a casino game that is in development to a potentially large number of potential players. These players can sample the game, and provide feedback regarding its features. That feedback can help in the development process, and can also contribute to the early identification of a game that is going to achieve acceptance, versus one that will not. It can also contribute to the development of demographic information concerning players who like a particular game, so as to enable new games to be placed in the markets where they are most likely to gain acceptance.

### SUMMARY OF THE INVENTION

In accordance with one embodiment of the present invention, a method for displaying casino games to a user is disclosed. The method comprises the steps of: a host receiving from a plurality of gaming manufacturers code sufficient to permit play of a plurality of casino games over a computer network; the host receiving from the plurality of users a membership fee in exchange for an ability to play the plurality of casino games on the personal computer; and the host permitting a plurality of users in networked communication with the host to play the casino game on a personal computer.

In accordance with another embodiment of the present invention, a method for displaying casino games to a user is disclosed. The method comprises the steps of: a host receiving from a plurality of gaming manufacturers code sufficient to permit play of a plurality of casino games over a computer network; wherein at least one of the casino games is in development, and cannot be found in a casino; the host receiving from the plurality of users a membership fee in exchange for an ability to play the plurality of casino games on the personal computer; the host permitting a plurality of users in networked communication with the host to play the casino game on a personal computer; the host obtaining from the user feedback regarding the at least one of the casino games that is in development; and the host communicating the feedback to one the gaming manufacturer associated with the casino game that is in development.

In accordance with a further embodiment of the present invention, a method for displaying casino games to a user is disclosed. The method comprises the steps of: a host receiving from a plurality of gaming manufacturers code sufficient to permit play of a plurality of casino games over a computer network; the host receiving from the plurality of users a membership fee in exchange for an ability to play the plurality of casino games on the personal computer; wherein at least one of the casino games can be found in a casino; the host permitting a plurality of users in networked communication with the host to play the casino game on a personal computer; and the host communicating to the plurality of users a casino location of the at least one casino game that can be found in a casino.

### BRIEF DESCRIPTION OF THE DRAWINGS

FIG. 1 is a block diagram of a system consistent with an embodiment of the present invention.

### DETAILED DESCRIPTION OF THE PREFERRED EMBODIMENTS

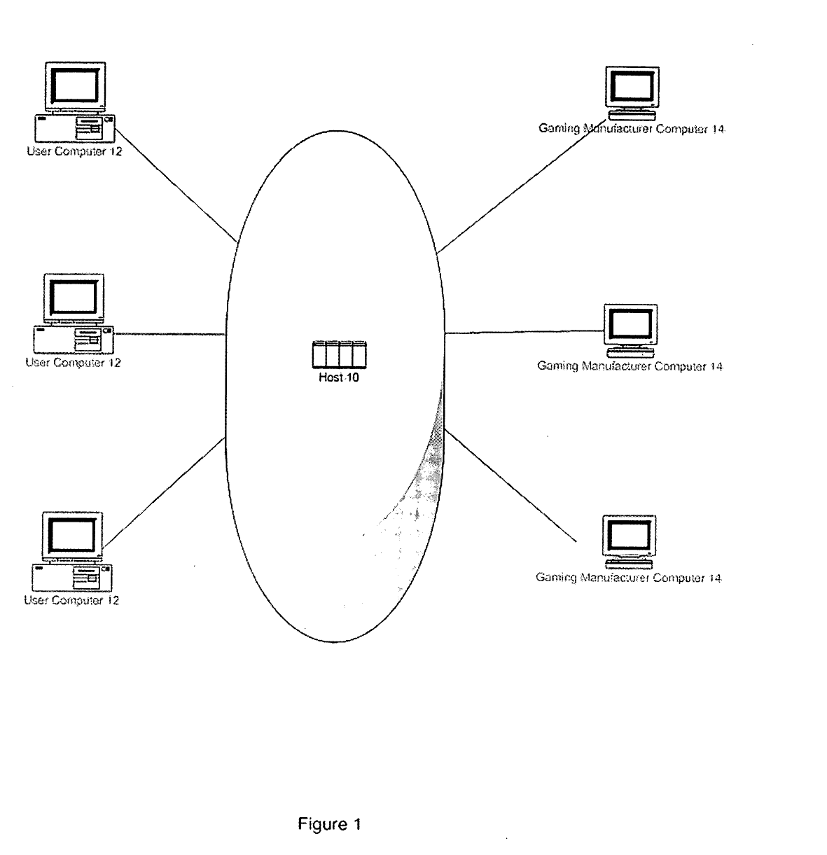

Referring first to FIG. 1, the basic configuration of a system configured to practice various embodiments of the present invention is shown. The main system components are a host 10, a plurality of user computers 12 in networked communication with the host 10, and a plurality of gaming manufacturer computers 14 in communication with the host 10.

With respect to the user computers 12, it should be noted that these can be personal computers (of a desktop, laptop, or other variety), PDA or other handheld device, or other apparatus capable of displaying a game as described herein and permitting the play of such a game by a user, and further capable of communicating with a host 10. It should further be noted that the communication may be hard-wired, such as by telephone line, DSL line, T1 line, cable modem, or the like, or may be wireless.

In one embodiment, a gaming manufacturer utilizing a gaming manufacturer computer 14 provides to a host 10 code sufficient to permit the simulated, interactive, play of a casino game that is in development. Such play is engaged in by a plurality of users, utilizing a user computer 12 or the like, which are in networked communication with the host 10.

Preferably, following the play of the game that is in development, the users are prompted to provide feedback regarding the game. Such feedback, preferably, is intended to elicit the user's reaction to the game, including identification of features the user may have liked, identification of features the user may not have liked, and whether or not the user would play the game in a casino setting. Preferably, the gaming manufacturer develops the feedback inquiries, provides them to the host 10 via gaming manufacturer computer 14, so that the host 10 may then communicate them to the users over the network.

As discussed in more detail below, it is preferred to require users to pay a membership fee in order to be able to participate in the simulated play of developing and/or existing games. It is preferred, in addition to requiring the payment of a fee, to further require the users to provide to the host 10 identifying, demographic-type information—such as age, sex, place of residence, identity of casinos typically visited, and the like. It would be preferred for the host 10 to provide such demographic information to the particular gaming manufacturer computer 14, with respect to a particular user who has played a game developed by the gaming manufacturer associated with the gaming manufacturer computer 14. Such information, particularly if provided together with feedback from that user and further length of play by the user of a particular game, can help the gaming manufacturer determine the likelihood that a particular game will gain acceptance, and further appropriate placement for a particular game.

With respect to existing games, a gaming manufacturer computer 14 provides to a host 10 computer code sufficient to permit the simulated, interactive, play of a casino game that is already in play in at least one casino. Such play is engaged in by a plurality of users, utilizing a user computer 12 or the like, which are in networked communication with the host 10.

As discussed above with respect to developing games, it would be preferable to provide gaming manufacturers, at a minimum, demographic information pertaining to users who play a particular existing game. Such information may be utilized by the gaming manufacturer to optimize placement of the game.

With respect to existing games, it is further preferred to display to users information regarding the identity and/or location of casinos where such games may be found. In this manner, a user who wishes to play in a casino setting a game sampled over a personal computer can determine where to go. It is also preferred to display to users information about the gaming industry, such as news, rules and regulations, and the like.

With respect to the game development and existing game features, and is illustrated in FIG. 1, it is preferred that there be a plurality of gaming manufacturers. In this manner, users should be exposed to a broad selection of games, and not only those of one manufacturer. This confers several benefits. It can permit a user to be exposed the games of multiple manufacturers from a single site, and can expose the user to games that he or she might not otherwise encounter by going from site to site.

It is preferred, to the greatest extent reasonable, that the play of both developing games and existing games over a user computer 12 be made as realistic as possible. In other words, the play over a user computer 12 should simulate actual play in a casino setting, in order to make the quality of feedback worthwhile, and in order to give players the feeling that they are having a casino-type experience.

Because wagering over the Internet is generally prohibited in the U.S. and other countries, users should not be required to place wagers in order to play an existing or developing game. Instead, preferably, users should be required to pay a fixed, membership fee in order to participate. More than one level of membership may be provided.

For example, a user may be entitled to 15 hours of playing time per month, in exchange for a payment of $29.99 per month. At another membership level, a player may be allotted 10 hours of game time per month, for $19.99 per month. Of course, the amount of money charged, amount of play time permitted, and payment period can be varied as desired.

It would further be preferred to permit players to purchase additional blocks of play time, after his or her allotted time for a particular period is exhausted. For example, users could be given the option of purchasing additional hours of play, for $2.99 per hour.

To increase player interest, it may be desired to provide players with the opportunity to participate in tournaments, contests, or the like. Preferably, these relate to the play of particular games, so that players can compete to become the champion with respect to a particular game. In this regard, players can be given the option of playing a particular game as a “championship” game, so that the system will track points achieved by the player during the play of that game. The system can track point totals for all players playing a particular game as a “championship” game, and determine which player has achieved the highest point total during a particular period. That player can receive a plaque or other suitable reward, as well as the display of his or her name on the system.

Players can also be provided with the opportunity to receive additional plays, or “spins,” for a particular game, upon correctly answering a trivia question or the like. Such an additional spin can be a “multiplier” spin, which can potentially multiply or otherwise increase the number of points that a player participating in a “championship” game has achieved.

To incentivize gaming manufacturers to permit the simulated play of their existing and/or developing games by the host 10, it is preferred for the host 10 to provide some consideration to the gaming manufacturers as compensation for this service. That consideration can take any desired form. It may be a percentage of membership fees collected, it may be a fixed dollar amount, it may be in the form of advertising, it may be some combination of these, and it may take any other desired form.

Preferably, as an added feature, the host computer will offer goods for sale, services for sale, and/or links to sites where goods or services may be purchased. As an added membership benefit, discounts may be offered on such purchases. Preferably, the amount of discount offered increases, the higher the membership level.

As a still added feature, it is preferred that the host 10 accept advertising from gaming manufacturers and perhaps others (e.g., casinos), which advertising should be displayed to users at appropriate times during their interaction with the host 10. For example, such advertisements may be displayed surrounding the portion of a computer screen displaying an existing or developing game that is being played by a user.

It is preferred that the feature of exposing players to games in development, as well as the feature of exposing players to existing games, be combined in a single method. However, it would be possible to provide a method that practices one feature, but not the other.

While the invention has been particularly shown and described with reference to preferred embodiments thereof, it will be understood by those skilled in the art that the foregoing and other changes in form and details may be made therein without departing from the spirit and scope of the invention.

1. A method for displaying casino games to a user comprising the steps of:
a host receiving from a plurality of gaming manufacturers code sufficient to permit play of a plurality of casino games over a computer network;
said host receiving from said plurality of users a membership fee in exchange for an ability to play said plurality of casino games on said personal computer; and
said host permitting a plurality of users in networked communication with said host to play said casino game on a personal computer.

2. The method of claim 1 further comprising the steps of:
said host obtaining from said plurality of users demographic information; and
said host communicating said demographic information to at least one gaming manufacturer.

3. The method of claim 1 wherein at least one of said casino games can be found in a casino.

4. The method of claim 1 wherein at least one of said casino games is in development, and cannot be found in a casino.

5. The method of claim 1 further comprising the step of providing more than one membership level, wherein an amount of said membership fee varies depending on said membership level.

6. The method of claim 1 further comprising the step of displaying to said plurality of users advertising information.

7. The method of claim 1 further comprising the step of said host providing consideration to at least one of said plurality of gaming manufacturers.

8. The method of claim 7 wherein said consideration is a percentage of said membership fee received by said host.

9. The method of claim 1 further comprising the steps of:
providing said plurality of users an option of playing said casino game as a “championship” game;
tracking points achieved during play of said game said plurality of users;
determining which of said plurality of users has achieved the highest total of said tracked points; and
awarding to said user having the highest total of said tracked points an award.

10. The method of claim 1 further comprising the step of displaying to said plurality of user information regarding at least one of an identity and a location of at least one casino where said game may be played.

11. A method for displaying casino games to a user comprising the steps of:
a host receiving from a plurality of gaming manufacturers code sufficient to permit play of a plurality of casino games over a computer network;
wherein at least one of said casino games is in development, and cannot be found in a casino;
said host receiving from said plurality of users a membership fee in exchange for an ability to play said plurality of casino games on said personal computer;
said host permitting a plurality of users in networked communication with said host to play said casino game on a personal computer;
said host obtaining from said user feedback regarding said at least one of said casino games that is in development; and
said host communicating said feedback to one said gaming manufacturer associated with said casino game that is in development.

12. The method of claim 11 further comprising the steps of:
said host obtaining from said plurality of users demographic information; and
said host communicating said demographic information to at least one gaming manufacturer.

13. The method of claim 11 further comprising the step of providing more than one membership level, wherein an amount of said membership fee varies depending on said membership level.

14. The method of claim 11 further comprising the step of said host providing consideration to at least one of said plurality of gaming manufacturers.

15. The method of claim 11 wherein said consideration is a percentage of said membership fee received by said host.

16. A method for displaying casino games to a user comprising the steps of:
a host receiving from a plurality of gaming manufacturers code sufficient to permit play of a plurality of casino games over a computer network;
said host receiving from said plurality of users a membership fee in exchange for an ability to play said plurality of casino games on said personal computer;
wherein at least one of said casino games can be found in a casino;
said host permitting a plurality of users in networked communication with said host to play said casino game on a personal computer; and
said host communicating to said plurality of users a casino location of said at least one casino game that can be found in a casino.

17. The method of claim 16 further comprising the step of said host obtaining from said plurality of users demographic information.

18. The method of claim 17 further comprising the step of said host communicating said demographic information to at least one gaming manufacturer.

19. The method of claim 16 further comprising the step of providing more than one membership level, wherein an amount of said membership fee varies depending on said membership level.

20. The method of claim 16 further comprising the step of displaying to said plurality of users advertising information.

21. The method of claim 16 further comprising the step of said host providing consideration to at least one of said plurality of gaming manufacturers.
